(19) United States
(12) Patent Application Publication
(10) Pub. No.: US 2011/0305850 A1
(43) Pub. Date: Dec. 15, 2011

(54) METHOD FOR THE PRODUCTION OF COATED RUBBER PARTICLES, COATED RUBBER PARTICLES, AND SOLVENT-FREE COATING FORMULATION

(75) Inventors: Andreas Berlineanu, Marl (DE); Kirsten Luce, Herne (DE); Margit Bukohl, Marl (DE); Nicole Dudek, Marl (DE); Siegfried Jittenmeier, Marl (DE); Marisa Cruz, Grosskrotzenburg (DE); Rainer Fuchs, Moembris (DE); Frank Dieter Kuhn, Gelnhausen (DE)

(73) Assignee: EVONIK DEGUSSA GmbH, Essen (DE)

(21) Appl. No.: 13/144,365

(22) PCT Filed: Dec. 29, 2009
(86) PCT No.: PCT/EP2009/067972

§ 371 Date: Sep. 2, 2011

(30) Foreign Application Priority Data
Jan. 13, 2009 (DE) 10 2009 000 180.8

(51) Int. Cl. E01C 13/08; B32B 1/00; B05D 3/02

(52) U.S. Cl. 428/17; 427/242; 428/407

(57) ABSTRACT

The invention describes a novel production process for coated particles composed of granulated-rubber material, the coating, the particles coated therewith and the uses of the coated particles. The coating formulation is solvent-free.

### FIELD OF THE INVENTION

The invention relates to a process for the coating of rubber particles, produced from used tyres, to the coating composition, and to the coating process and to the coated rubber particle, and also to its use as infill in artificial turf or for other floorcoverings, for example in the construction of sports facilities. It is also possible to coat other rubber surfaces and to coat articles composed of rubber.

### PRIOR ART

EP 1 416 009 (Mülsener Recycling- and handelgesellschaft mbgH) describes a loose, flowable granulated-rubber material, covered with a binder based on polyurethane. The binder can optionally also be coloured. The diameter of the rubber particles is from 0.5 mm to 2.5 mm, and the average layer thickness of the coating is from 5 micrometres to 20 micrometres, and at some locations the thickness of the layer can be up to 35 micrometres. There is no disclosure of mechanical or chemical properties of the coated rubber particles.

DE 196 31 251 (ContiTech Holdings) describes a granulated-rubber product coated with a flame-retardant binder covering. The binder used comprises a rubber, and the flame retardant used comprises inorganic flame retardants, such as magnesium hydroxide or aluminium hydroxide. The granulated-rubber products provided with the low-flammability coating are processed to give low-flammability rubber workpieces.

DE 24 55 679 (Bayer AG) describes the coating of rubber particles whose diameter is from 0.5 to 6 mm with a binder based on polyisocyanates, these coated particles being further processed to give elastic floorcoverings.

DE 25 24 877 (Schramm) describes a floorcovering, for example for floors of animal stalls, composed of coated particles, the covering being hardened in situ. No further information is given in relation to the physical properties of the coating.

DE 21 10 327 (Allwelt) describes a production process for elastic sports floors composed of granulated material derived from used tyres and of binder. Granulated material and binder are mixed and hardened to give the floor.

The four last-mentioned patent publications do not describe any granular, flowable product which could be used as infill for artificial turf, efforts being instead mainly directed towards the crosslinking of the coated particles obtained to give a solid floorcovering.

DE 196 38 312 (Martin) describes a jointless insulation material composed of granulated rubber material and of a binder, where the binder used comprises an epoxy resin or a (meth)acrylate resin.

WO 2002/18706 (Fieldturf Inc.) describes a transportable, modular artificial turf element composed of turf surface element and base element and of infill for the turf surface element. The infill can be composed of rubber particles not specified in any great detail, or of sand or of a mixture composed of sand and rubber particles. No coating of the rubber particles is mentioned.

WO 2002/060290 (Groundscape Technologies LLC) describes a material composed of vulcanized rubber particles, and of a first, coloured coating layer, which covers the vulcanized rubber particles, and of a second coating layer, which protects the coloured coating layer from abrasion. The second coating layer comprises, as binder, a polyacrylate, a polyurethane or a styrene/butadiene rubber.

US 2002/0128366 (Coffey) describes a process for the production of coloured particles composed of vulcanized rubber, encompassing the following steps: an aqueous pigment dispersion is added to the as yet uncoloured vulcanized rubber particles, and the two constituents are mixed until the rubber particles have been coloured, and then an elastomer latex is added, and mixing is repeated, and the latex is permitted to set. The elastomer used comprises either a styrene/butadiene rubber or a polybutadiene rubber.

DE 103 45 964 (Weitzel) describes a granulated material composed of rubber particles and provided with a mineral-containing coating. A disadvantage of this mineral-containing coating is the fact that the mineral-containing coating is substantially less elastic than the binder and can therefore have a tendency to break apart.

### DISADVANTAGES OF THE PRIOR ART

A disadvantage of the prior art cited is that no physical and/or chemical data are disclosed which provide evidence of the long-term weathering resistance required for artificial-turf-infill materials. Data are moreover lacking in relation to the abrasion resistance of the coated rubber particles, this being an important property for problem-free play on the sports facilities equipped with artificial-turf-infill materials, because an excessive level of abrasion leads to a high level of dusting, and an excessive proportion of agglomerated particles leads to uncontrolled and unpredictable ball-bounce performance.

A further intention was to develop a simple coating process for the granulated-rubber materials, in order to comply with requirements for low-cost production.

### OBJECT

In view of the prior art cited above, with its disadvantages, the objects were then to provide a further production process for the production of a free-flowing granulated-rubber material. The process is intended to be simple and to be readily capable of scale-up and to operate without solvent. The process is moreover intended to be inexpensive.

DIN V 18035-7 (preliminary standard) sets out the technical requirements placed upon an artificial-turf surface for sports facilities. The said standard is applicable to a wide variety of types of sport, examples being football, hockey, American football and tennis.

The fill materials have to have a certain level of resistance when exposed to moisture, and to the resultant leaching of in particular aqueous solutions comprising heavy metals, since DIN V 18035-7 (preliminary standard) provides that there can be means provided for the moistening of the artificial-turf surface, in order to improve sports characteristics and risk-prevention characteristics, and in order to reduce wear.

Line 19 of Table 6 of the standard says that elastic fillers can by way of example be composed of EPDM vulcanizate and/or recycled rubber. The grain size range is intended to be from 0.5 to 4 mm, and the proportion of constituents below 0.5 mm here is intended to be less than 1%. The grains are intended to be of angle-cut shape.

### ACHIEVEMENT OF OBJECT

The objects are achieved via a process of claim 1 or of claim 2. Other advantageous embodiments are protected by the dependent claims.

The objects are achieved via a multicomponent system for the coating of granulated-rubber products in a fluidized-bed apparatus, a solids mixer, or in a drum mixer. This system is composed of a binder component based on epoxy resin and of an anhydride hardener. The crosslinking reaction can be promoted by various catalysts.

The hardening of the coating takes place in the temperature range from 60 degrees Celsius to 150 degrees Celsius, preferably in the temperature range from 80 degrees Celsius to 120 degrees Celsius.

The mixture can also be heated by infrared sources, and the heating can also take place in a second step.

It is moreover possible to use the mixture of the invention not only to coat rubber particles but also to coat rubber surfaces or rubber coverings.

### Constitution of the Coating

The binder component can be composed of one or more epoxy resins. Those that can be used here are the traditional bisphenol A resins, bisphenol F resins, bisphenol AF resins, cycloaliphatic epoxy resins and epoxy resins based on hydrogenated bisphenol A. Solid resins can usefully be dissolved in reactive diluents, examples being aliphatic monoglycidyl ethers, cresyl glycidyl ether, p-tert-butylphenol glycidyl ether, butanediol diglycidyl ether, hexanediol diglycidyl ether, trimethylolpropane triglycidyl ether etc. and in low-viscosity, liquid epoxy resins.

This binder component can be a mixture composed of the substances mentioned, but can also comprise pigments, fillers, such as finely ground silicon dioxide (powdered quartz, for example Sikron SF 800 from Quarzwerke GmbH; the quartz sand is preferably a silanized grade (Silbond FW 600 EST) to achieve better coupling to the polymer matrix, for example by using glycidyloxymethylpropyltrimethoxysilane, produced and marketed by Evonik Degussa GmbH with trade name Dynasylan® GLYMO), additives, antioxidants, UV absorbers, solvents, flow control agents, and catalysts. However, it is preferable to use a cycloaliphatic epoxy resin known as Epikote® Resin 760 from Hexion.

The anhydride hardener can comprise maleic-anhydride-modified polymers based on a variety of chemicals and/or methylhexahydrophthalic anhydride (Epikure® Curing Agent 868, Hexion), methyltetrahydrophthalic anhydride (Epikure® Curing Agent 866, Hexion).

Maleic-anhydride-modified polymers are polyalkenylenes, preferably based on 1,3-butadiene, isoprene, 2,3-di-methyl-1,3-butadiene and chloroprene.

Homo- or copolymers of the abovementioned monomers can be used, but preference is given to homopolymers, especially those of 1,3-butadiene. The polyalkenylenes can have 1,4 linkage or 1,2 linkage. However, it is equally possible to use a mixture composed of 1,2 and 1,4 linkages, where the arrangements assumed by the 1,4 linkage can be cis or trans arrangements. It is very particularly preferable to use a polybutadiene having about 75% of 1,4-cis double bonds, about 24% of 1,4-trans double bonds and about 1% of 1,2 double bonds (Polyoil, Degussa).

It is also possible to use polyalkenylenes which are composed of at least one of the abovementioned mono-meric dienes and one or more vinyl compounds and/or alkenes. Examples of suitable vinyl compounds are styrenes or substituted styrenes, vinyl ethers, and, respectively, esters of acrylic or methacrylic acid. Examples of suitable alkenes are ethene, propene, butene or isobutene. Natural oils can also be modified with maleic anhydride, examples being coconut oil, palm oil, castor oil, olive oil, peanut oil, rapeseed oil, soya oil, sunflower oil, poppy oil, linseed oil, wood oil, etc.

The maleic-anhydride-modified polymers can comprise from 1 to 20 per cent by weight of maleic anhydride. The preferred content of maleic anhydride is from 7 to 14 per cent by weight.

By way of example, the maleic-anhydride-modified polymer used comprises the product POLYVEST® OC. 800 S, POLYVEST® EP OC 1000 S or POLYVEST® EP OC 1200 S. POLYVEST® OC 800 S is a maleic-anhydride-modified Polyoil 110 from Degussa and is obtainable with this name from Evonik Degussa GmbH.

POLYVEST® OC 800 S and POLYVEST® EP OC 1200 S contain randomly distributed succinic anhydride units. This makes the polybutadiene, which is initially non-polar, more polar and accessible to various chemical reactions. POLYVEST® OC 800 S and POLYVEST® EP OC 1200 S have good electrical insulation properties and low-temperature properties. POLYVEST® OC 800 S and POLYVEST® EP OC 1200 S are soluble in aliphatics, aromatics, and ethers, and are compatible with long-oil alkyd resins, colophony, resin esters and zinc resinates. They can be used as crosslinking agent component in 2C systems, as polymeric chalk activator for rubber mixtures, and in particular for EPDM mixtures and for water-soluble, oxidatively drying binders.

The hardener component can optionally be formulated in the form of clear coat or filled system.

Further components that can therefore optionally be added to the hardener component are organic and/or inorganic pigments, wetting agents, dispersing agents, lubricants, organic and/or inorganic fillers, anti-oxidants, UV absorbers, UV stabilizers, IR absorbers, flow aids or flow control agents.

Catalysts can be used to accelerate the crosslinking reaction.

These catalyst can be added, prior to the application process, as third component of the mixture composed of binder component and of hardener component.

Admixture to the binder component or hardener component is also possible. Tertiary amines can be used as catalyst, examples being triethylamine, cyclohexyl-dimethylamine, benzyldimethylamine, N-methylimidazole, organic titanates, zirconates, and zinc carboxylates and bismuth carboxylates.

Binder component B

| | Component B | | |
|---|---|---|---|
| | B1 | B2 | B3 |
| Epikote Resin 760 | 73.2 | 72.8 | 45.4 |
| Tegomer E-Si 2330 | — | 5.2 | 1.4 |
| Tego Dispers 650 | — | — | 0.4 |
| Blanc fixe micro | 13.2 | 8.4 | 30.3 |
| Kronos 2190 | 10 | 10 | 15 |
| Heliogen Green L 8730 | 2 | 2 | 0.5 |
| Hostaperm Yellow H3G | 0.6 | 0.6 | 6 |
| Wingstay L | 1 | 1 | 1 |
| | 100 | 100 | 100 |

The amounts specified are always parts by weight.

### Hardener Component A

| | Component A | | |
|---|---|---|---|
| | A1 | A1 | A2 |
| Epikure Curing Agent 868 | 10 | 10 | 30 |
| Polyvest OC 800 S | 60 | 60 | — |
| Polyvest EP OC 1200 S | — | — | 70 |
| Blanc fixe micro | 11 | 11 | — |
| Kronos 2190 | 15 | 15 | — |
| Heliogen Green L 8730 | 3 | 3 | — |
| Hostaperm Yellow H3G | 1 | 1 | — |
| | 100 | 100 | 100 |

### Mixing Ratio

| | Coating:hardener | | |
|---|---|---|---|
| | B1:A1 | B2:A1 | B3:A2 |
| Mixing ratio | 1:4 | 1:4 | 1:1 |

### Catalyst

| | Coating:hardener | | |
|---|---|---|---|
| | B1:A1 | B2:A1 | B3:A2 |
| 100% by weight of | 3.2 | 3.2 | 1.4 |
| Epikure | | | |

The particles to be coated comprise rubber particles which are preferably obtained by recycling of used tyres. The size of the rubber particles is from 0.1 mm to 10 mm, preferably from 0.5 mm to 7.5 mm and particularly preferably from 0.4 mm to 4 mm.

Since, by virtue of the production process, the rubber particles do not have a regular shape, the above values are to be understood purely as guideline values.

The thickness of the coating is from 1 μm to 100 μm, preferably from 2 μm to 50 μm and very particularly preferably from 5 μm to 25 μm.

Since, by virtue of the production process, the rubber particles do not have a regular shape, the above values are to be understood purely as guideline values. In particular, coatings which locally have significantly greater thickness can be produced via filling of cavities of the rubber particles.

The components can be applied in premixed form or by way of a multicomponent mixing system, for example a 2C mixing and spraying system. The coating material needed for the coating process, composed of component A and of component B and of catalyst component, can be applied once or in a plurality of steps. After application of each individual layer, coating can continue immediately, or a crosslinking step (time, heat) can be inserted.

### WORKING OF THE INVENTION

A mixture B composed of a
cycloaliphatic epoxy resin,
using from 10% by weight to 80% by weight of cycloaliphatic epoxy resin, preferably from 40% by weight to 80% by weight of cycloaliphatic epoxy resin and very particularly preferably 45% by weight of cycloaliphatic epoxy resin,
of amounts of from 0.1% by weight to 5.9% by weight of silicone oil,
of amounts of from 0.1% by weight to 2.9% by weight of a wetting and dispersing agent,
of antioxidant,
of barium sulphate,
using from 1% by weight to 50% by weight of barium sulphate, preferably from 20% by weight to 45% by weight of barium sulphate and very particularly preferably from 30% by weight to 40% by weight of barium sulphate,
of titanium dioxide,
of further pigments, (where the other components give a total of 100% by weight)
   and a mixture A composed of an
aliphatic anhydride,
using from 1% by weight to 50% by weight of aliphatic anhydride, preferably from 5% by weight to 40% by weight of aliphatic anhydride and very particularly preferably from 7% by weight to 30% by weight of aliphatic anhydride, and
of an MA-modified polybutadiene,
using from 99% by weight to 50% by weight of MA-modified polybutadiene, preferably from 90% by weight to 65% by weight of MA-modified polybutadiene and very particularly preferably 70% by weight of MA-modified polybutadiene
   are mixed in a ratio of from 10 parts by weight of mixture B:1 part by weight of mixture A to 1 part by weight of mixture B:10 parts by weight of mixture A, and catalyst is admixed with this mixture and this material is mixed with the granulated-rubber material at from 80 degrees Celsius to 120 degrees Celsius in a drum mixer. It is also possible to set other mixing ratios and to omit the premixing of the coating components, and to add them simultaneously to the initial charge of granulated-rubber material. The table states the preferred mixing ratios.

### Preparation of Mixture B

The mixture B3 can be prepared as follows:
45.4% by weight of Epikote Resin 760 (cycloaliphatic epoxy resin, Hexion),
1.4% by weight of Tegomer E-Si 2330 (silicone oil, Evonik),
0.4% by weight of Tego Dispers 650 (wetting and dispersing agent, Evonik),
30.3% by weight of Blanc fixe micro (barium sulphate filler, Sachtleben),
15% by weight of Kronos 2190 (TiO₂ pigment, Kronos),
0.5% by weight of Heliogen Green L 8730 (pigment, BASF),
6% by weight of Hostaperm Yellow H3G (pigment, Clariant), and
1% by weight of Wingstay L (antioxidant; Eliokem)
are dispersed and ground in a bead mill until the grains are appropriately fine.

### Preparation of Mixture A

The mixture A2 is prepared and stored under nitrogen. For this,
30 parts by weight of Epikure Curing Agent 868 (aliphatic anhydride, Hexion)
are mixed, with stirring, with
70 parts by weight of Polyvest EP OC 1200 S (specific MA-modified polybutadiene from Evonik)
until the resultant formulation is homogeneous.

The formulations of the invention have excellent properties, examples being abrasion values, prior to and after exposure to light and weathering, and elasticity prior to and after exposure to light and weathering, and are resistant to the effects of weathering. The formulations of the invention moreover have excellent colourfastness after exposure to light and weathering, and also excellent stability when subjected to temperature changes, and when subjected to high temperatures, for example at 50 degrees Celsius over a period of 4 weeks. The formulations of the invention moreover dry easily.

In a further embodiment, the flowable particles of the invention can, for example in situ, be provided with an adhesive or polymerizing or crosslinking layer which permits the particles to be cast into a matrix of any desired shape and to be hardened. The polymer matrix used can comprise polyurethane resins or epoxy resins. Any desired colour effects can be achieved through different colourings of matrix and granulated-rubber material.

The mixture of the invention can be used not only rubber particles but also three-dimensional articles composed of rubber, or articles with a surface composed of rubber, for example toys, rubber mats, or the outer walls of tyres.

1. A process for coating at least one rubber particle, the process comprising:
mixing
a mixture A comprising an
aliphatic anhydride, and
an MA-modified polybutadiene,
with
a mixture B comprising
a cycloaliphatic epoxy resin,
silicone oil,
a wetting agent;
a dispersing agent,
antioxidant,
at least one filler,
at least one pigment, and
catalyst
in a drum mixer with the at least one rubber particle, to obtain at least one coated rubber particle; and
hardening the at least one coated rubber particle at from 80° C. to 120° C.

2. The process of claim 1, carried out in a fluidized-bed reactor.

3. The process of claim 1, carried out in a solids mixer.

4. A coated rubber particle, obtained by the process of claim 1.

5. A method of constructing a sports facility, the method comprising combining or integrating the coated rubber particle of claim 4 with or into a part of the sports facility.

6. A method of producing an artificial turf, the method comprising combining the coated rubber particle of claim 4 with the artificial turf.

7. An artificial turf, comprising, infilled, the coated rubber particle of claim 4.

8. A unit of landscape architecture, comprising the coated rubber particle of claim 4.

9. A covering, comprising a filler comprising the coated rubber particle of claim 4.

10. A coated rubber, obtained by the process of claim 1.

11. An article comprising coated rubber, obtained by the process of claim 1.

12. A coated rubber particle, obtained by the process of claim 2.

13. A method of constructing a sports facility, the method comprising combining or integrating the coated rubber particle of claim 12 with or into a part of the sports facility.

14. A method of producing an artificial turf, the method comprising combining the coated rubber particle of claim 12 with the artificial turf.

15. An artificial turf, comprising, infilled, the coated rubber particle of claim 12.

16. A unit of landscape architecture, comprising the coated rubber particle of claim 12.

17. A covering, comprising a filler comprising the coated rubber particle of claim 12.

18. A coated rubber particle, obtained by the process of claim 3.

19. A method of constructing a sports facility, the method comprising combining or integrating the coated rubber particle of claim 18 with or into a part of the sports facility.

20. A method of producing an artificial turf, the method comprising combining the coated rubber particle of claim 18 with the artificial turf.
